(19) United States
(12) Patent Application Publication
(10) Pub. No.: US 2024/0334231 A1
(43) Pub. Date: Oct. 3, 2024

(54) Method And Apparatus For Measurement Resource And Report Configuration For Device Collaborative Communications

(71) Applicant: MediaTek Inc., Hsinchu City (TW)

(72) Inventors: Lung-Sheng Tsai, Hsinchu City (TW); Chia-Hao Yu, Hsinchu City (TW); Cheng-Rung Tsai, Hsinchu City (TW); Chi-Hsuan Hsieh, Hsinchu City (TW)

(21) Appl. No.: 18/595,517

(22) Filed: Mar. 5, 2024

Related U.S. Application Data
(60) Provisional application No. 63/493,332, filed on Mar. 31, 2023.

(51) Int. Cl. H04W 24/10; H04L 5/00

(52) U.S. Cl. CPC H04W 24/10; H04L 5/0048

(57) ABSTRACT

Examples pertaining to measurement resource and report configuration for a communication apparatus supporting device collaboration in mobile communications are described. A user equipment (UE) receives a first report configuration associated with at least a first measurement resource allocated in a first frequency band from a network node. The UE determines information regarding a second measurement resource allocated in a second frequency band which is different from the first frequency band. The UE receives a first radio frequency (RF) signal carrying one or more reference signals on the first measurement resource and receives a second RF signal carrying identical one or more reference signals on the second measurement resource.

### CROSS REFERENCE TO RELATED PATENT APPLICATION(S)

The present disclosure is part of a non-provisional application claiming the priority benefit of U.S. Patent Application No. 63/493,332, filed 31 Mar. 2023, the content of which herein being incorporated by reference in its entirety.

### TECHNICAL FIELD

The present disclosure is generally related to mobile communications and, more particularly, to measurement resource and report configuration for device collaborative communications.

### BACKGROUND

Unless otherwise indicated herein, approaches described in this section are not prior art to the claims listed below and are not admitted as prior art by inclusion in this section.

Massive multiple-input multiple-output (MIMO) technology plays a crucial role in boosting spectral efficiency and signal robustness in fifth generation (5G) New Radio (NR). With the breakthrough of practical antenna systems, accommodating large numbers of digital antenna ports at a network node has become feasible from an implementation standpoint.

Although the MIMO enhancement has been achieved at the network side, physical hardware limitation at the UE side is still a bottleneck for MIMO gain improvement.

Accordingly, device collaborative communications to improve the overall MIMO performance at the UE side and corresponding measurement resource and report configuration for device collaborative communications becomes important issues for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to measurement resource and report configuration for a communication apparatus supporting device collaboration in mobile communications.

In one aspect, a method may involve an apparatus receiving a first report configuration from a network node, wherein the first report configuration is associated with at least a first measurement resource allocated in a first frequency band; determining information regarding a second measurement resource allocated in a second frequency band, wherein the first frequency band is different from the second frequency band; receiving a first radio frequency (RF) signal carrying one or more reference signals on the first measurement resource; and receiving a second RF signal carrying said one or more reference signals on the second measurement resource. Said one or more reference signals carried in the first RF signal and said one or more reference signals carried in the second RF signal are identical.

In one aspect, an apparatus may involve a transceiver which, during operation, wirelessly communicates with at least one network node. The apparatus may also involve a processor communicatively coupled to the transceiver such that, during operation, the processor performs following operations: receiving, via the transceiver, a first report configuration from the network node, wherein the first report configuration is associated with at least a first measurement resource allocated in a first frequency band; determining information regarding a second measurement resource allocated in a second frequency band, wherein the first frequency band is different from the second frequency band; receiving, via the transceiver, a first radio frequency (RF) signal carrying one or more reference signals on the first measurement resource; and receiving, via the transceiver, a second RF signal carrying said one or more reference signals on the second measurement resource. Said one or more reference signals carried in the first RF signal and said one or more reference signals carried in the second RF signal are identical.

In one aspect, a method may involve a base station receiving a capability report from a communication apparatus which receives signals from the base station in a first frequency band, wherein the capability report comprises information regarding a capability of supporting device collaboration and information regarding at least a second frequency band to perform the device collaboration, and wherein the first frequency band is different from the second frequency band; configuring a first measurement resource in the first frequency band; and transmitting a first report configuration associated with the first measurement resource. Information regarding a second measurement resource allocated in the second frequency band is implicitly or explicitly indicated by the first report configuration.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a mobile communications network in accordance with implementations of the present disclosure.

FIG. 2 is a diagram depicting an example scenario of diversity augmentation based on device collaboration in accordance with implementations of the present disclosure.

FIG. 3 is a diagram depicting an example scenario of rank augmentation based on device collaboration in accordance with implementations of the present disclosure.

FIG. 4 is a diagram depicting an example scenario of transceiving capability augmentation based on device collaboration in accordance with implementations of the present disclosure.

FIG. 5 is a diagram depicting an example communication system having an example communication apparatus and an example network apparatus in accordance with an implementation of the present disclosure.

FIG. 6 is a diagram depicting an example process in accordance with an implementation of the present disclosure.

FIG. 7 is a diagram depicting an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to measurement resource and report configuration for device collaborative communications, e.g., measurement resource and report configuration for a communication apparatus supporting device collaboration in mobile communications. According to the present disclosure, a number of possible solutions may be implemented separately or jointly. That is, although these possible solutions may be described below separately, two or more of these possible solutions may be implemented in one combination or another.

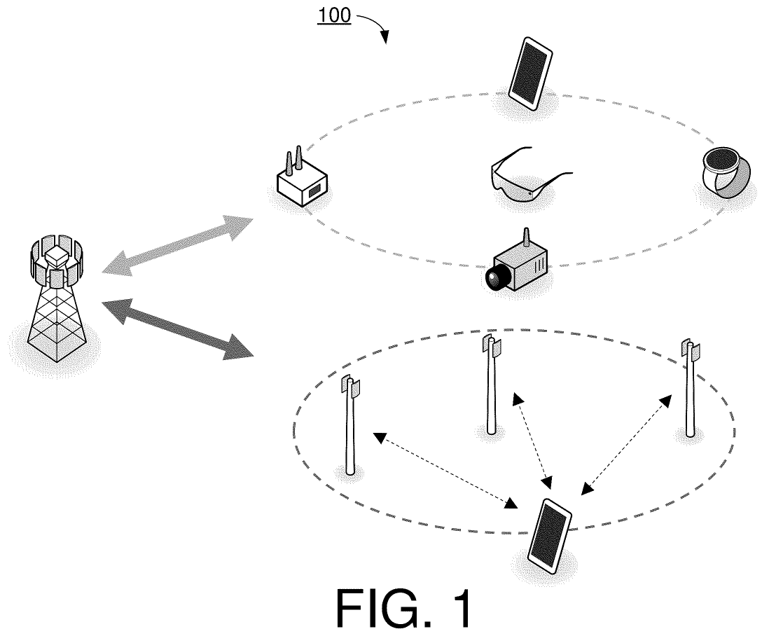

FIG. 1 illustrates an example scenario 100 of a mobile communications network to implement device collaboration in accordance with implementations of the present disclosure. A personal area network (PAN) may support extended reality (XR)-like services, such as XR glasses with a mobile phone or a customer premises equipment (CPE). A public network may comprise one or more repeaters and mobile phones. In some implementations, at least one device may be a collaborating communication apparatus in device collaborative communications to facilitate augmentation in transceiving capability (e.g., antenna capability, diversity, rank, or others) of a primary communication apparatus in the mobile communications network.

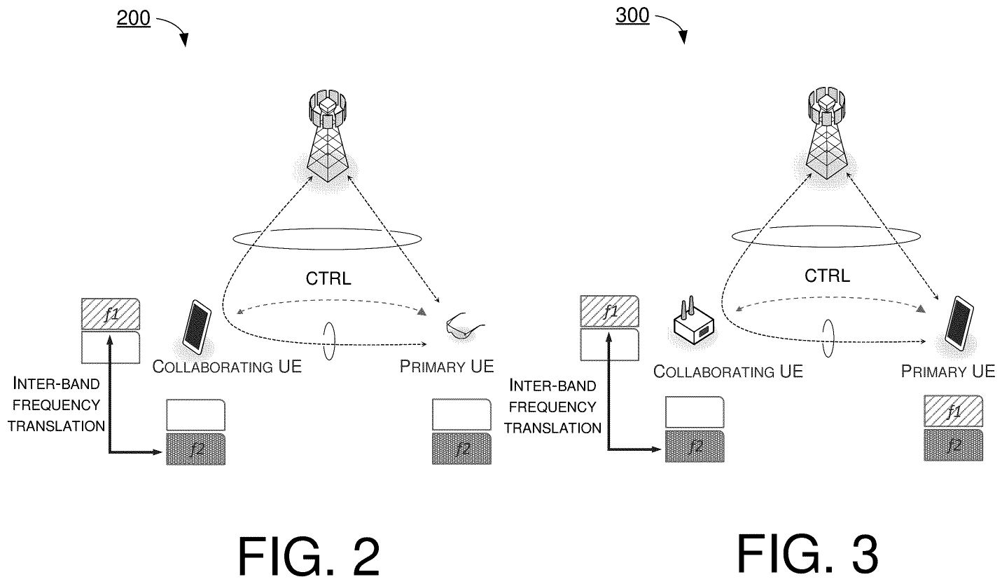

FIG. 2 illustrates an example scenario 200 of diversity augmentation based on device collaboration in accordance with implementations of the present disclosure. A high-capability device (e.g., a smartphone) may serve as a proxy to provide a good-quality data path for a low-capability device (e.g., XR glasses). In this device collaboration scenario, the high-capability device may be a collaborating communication apparatus or a collaborating UE and the low-capability device may be a primary communication apparatus or a primary UE. A device-control path CTRL may be established between the primary UE and the collaborating UE to exchange critical information, including channel state information (CSI), repeater-mode enabling, power control etc.

The collaborating UE may communicate with a network node (such as a satellite, a base station or a network apparatus in the mobile communications network) in a first frequency band f1 and communicate with the primary UE in a second frequency band f2. Each frequency band is an interval in frequency domain. The collaborating UE may perform inter-band frequency translation to shift the radio frequency (RF) carrier of the received signal from the first frequency band f1 to the second frequency band f2 and vice versa. This device collaboration is applicable to both uplink and downlink transmissions.

Compared to smartphones, a wearable device typically has less capability in terms of MIMO processing capability, number of transmitting (Tx) or receiving (Rx) antennas, carrier aggregation (CA) capability, etc. FIG. 2 illustrates that the collaborating UE (e.g., a 4Rx smartphone) as an intermediate node works together with a 2Rx wearable device with 1 component carrier (CC) capability. The smartphone may act as an advanced amplify and forward (AF) repeater with better Rx beamforming capability (i.e., more receive antennas), and may purify signal quality by rejecting interference coming from un-expected directions, and forward processed signal to the low-capability wearable device.

FIG. 3 illustrates an example scenario 300 of rank augmentation based on device collaboration in accordance with implementations of the present disclosure. One smartphone and one collaborating device (such as a relay device, another smartphone, an indoor CPE, or others) collaborate to receive, at the smartphone, a resulting high-rank data signal transmitted from the network node (such as a satellite, a base station or a network apparatus in the mobile communications network).

In this device collaboration scenario, the smartphone may be a primary communication apparatus or a primary UE and the aforementioned collaborating device may be a collaborating communication apparatus or a collaborating UE. The primary UE may communicate with the network node in a first frequency band f1 and communicate with the collaborating UE in a second frequency band f2. The collaborating UE may communicate with the network node in the first frequency band f1 as the primary UE does, and communicate with the primary UE in the second frequency band f2. The collaborating UE may perform inter-band frequency translation to shift the RF carrier of the received signal from the first frequency band f1 to the second frequency band f2 and vice versa. This device collaboration is also applicable to both uplink and downlink transmissions.

A device-control path CTRL may be established between the primary UE and the collaborating UE to exchange critical information, including CSI, repeater-mode enabling, power control etc. The primary UE utilizes its CA capability to receive signals directed from the base-station and the collaborating UE simultaneously in two bands f1 and f2 and processes the received signals jointly, as if having two sets of Rx antennas. The network node transmits a signal in frequency band f1 to an end-device that appears to be equipped with two sets of Rx antennas in a single band, so the rank of the end-to-end MIMO channel rank is doubled.

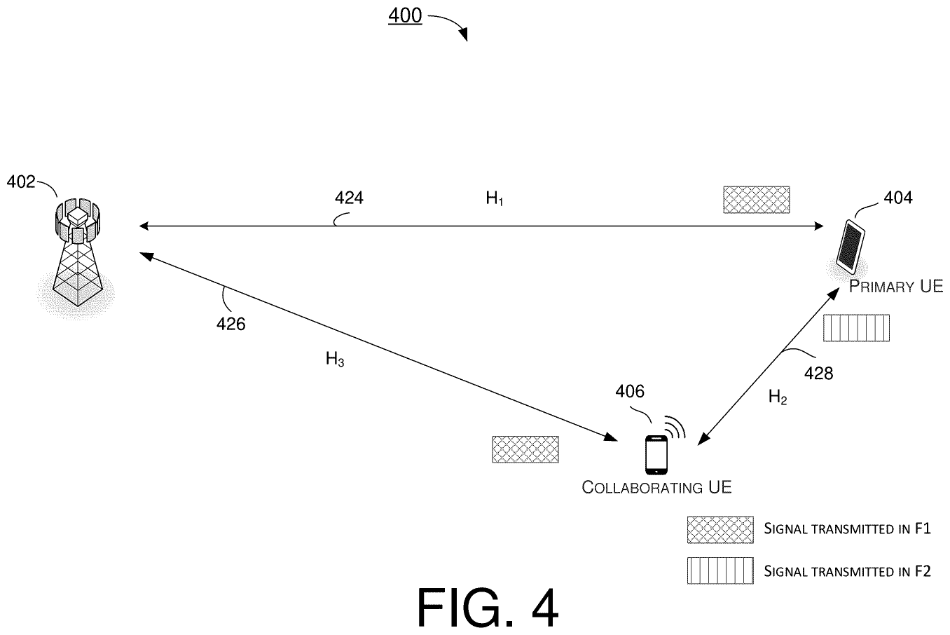

FIG. 4 illustrates an example scenario 400 of transceiving capability augmentation based on device collaboration in accordance with implementations of the present disclosure. A collaborating communication apparatus (denoted as collaborating UE 406 in FIG. 4) may be placed near a primary communication apparatus (denoted as primary UE 404 in FIG. 4) or placed between a network node 402 (such as a satellite, a base station or a network apparatus in the mobile communications network) and the primary UE 404.

The primary UE 404 may communicate with the network node 402 in a first frequency band f1 and communicate with the collaborating UE 406 in a second frequency band f2. The collaborating UE 406 may communicate with the network node 402 in the first frequency band f1 as the primary UE 404 and communicate with the primary UE 404 in the second frequency band f2. The collaborating UE 406 may perform inter-band frequency translation to shift the RF carrier of the received signal from the first frequency band f1 to the second frequency band f2 and vice versa. This device collaboration is also applicable to both uplink and downlink transmissions

In some implementations of device collaborative communications, for uplink transmission, the primary UE 404 may simultaneously or substantially simultaneously transmit signals on two different time-frequency resources or in two different frequency bands f1 and f2.

In some implementations, the two time-frequency resources (e.g., the first time-frequency resources and the second time-frequency resources) do not overlap with each other. In some implementations, the first time-frequency resources and the second time-frequency resources do not overlap with each other in a frequency domain. In some implementations, the first time-frequency resources and the second time-frequency resources do not overlap with each other in a frequency domain and overlap with each other in a time domain.

In some implementations, the first time-frequency resources and the second time-frequency resources are in two non-overlapped bands, in two non-overlapped component carriers, or in two non-overlapped sets of resource blocks within a component carrier.

In some implementations, the first frequency band and the second frequency band do not overlap with each other. In some implementations, a position of the second frequency band is a constant offset relative to the first frequency band. In some implementations, the first frequency band and the second frequency band are two non-overlapped component carriers.

In some implementations, the primary UE 404 may comprise multiple physical antennas, and the physical antennas may be shared on the two different time-frequency resources or the two different frequency bands to reduce chip area cost of the primary UE 404. Note that the primary UE 404 may also use two different groups of antennas to respectively transmit signals on two different time-frequency resources or in two different frequency bands, and the invention is not limited to any type of implementation.

In one example, the primary UE 404 may have 4 physical antennas (i.e., physical antennas 1 to 4) and may have 4 layers of data (i.e., layers 1 to 4) to be transmitted. Further, each layer of data corresponds to an antenna port. In a first configuration, the primary UE 404 maps a particular layer to a particular physical antenna. For example, the layer 1 data is transmitted through the physical antenna 1, the layer 2 data is transmitted through the physical antenna 2, and so on. This may be referred to as a non-coherent mode. In a second configuration, at the primary UE 404, at least one particular layer is mapped to at least two physical antennas and at least one physical antenna is not mapped with at least one layer of the 4 layers of data. For example, the layer 1 data is transmitted through the physical antenna 1 and the physical antenna 2, the layer 2 data is transmitted through the physical antenna 3 and the physical antenna 4, . . . , and so on. This may be referred to as a partial-coherent mode. In a third configuration, each layer of data is mapped to all physical antennas. This is referred to as a full-coherent mode.

For some detailed explanation using signal models, in some implementations, the primary UE 404 may generate 4 layers baseband data signals x₁, x₂, . . . , x₄, which are the data signals to be transmitted to the network node and may be represented by a vector:

$${x}_{4 \times 1} = [ \begin{matrix}{x}_{1} \\ {x}_{2} \\ {x}_{3} \\ {x}_{4}\end{matrix} ]$$

The primary UE 404 may divide the symbol x_{4×1} into two groups of signals x_{2×1}⁽¹⁾ and x_{2×1}⁽²⁾, where the first signal x_{2×1}⁽¹⁾ is to be transmitted to the network node 402 through the channel 424 (which may be regarded as a direct path or direct link) and the second signal x_{2×1}⁽¹⁾ is to be transmitted to the collaborating UE 406 and then transmitted to the network node 402 through the channels 428 and 426 (which may be regarded as an indirect path or indirect link). The primary UE 404 may apply a first precoder represented as P′_{2×2}⁽¹⁾ on the first signal x_{2×1}⁽¹⁾, and apply a second precoder represented as P′_{2×2}⁽²⁾ on the second signal x_{2×1}⁽²⁾. As an example, the primary UE 404 may map the first signal x_{2×1}⁽¹⁾ to a first group of physical antennas (e.g., comprising two physical antennas) to generate two superimposed signals represented as P′_{2×2}⁽¹⁾·x_{2×1}⁽¹⁾, and map the second signal x_{2×1}⁽²⁾ to a second group of physical antennas (e.g., comprising two physical antennas) to generate two superimposed signals represented as P′_{2×2}⁽²⁾·x_{2×1}⁽²⁾.

Further, the primary UE 404 may mix the superimposed signals with the corresponding RF carriers and transmit the resulting RF signals at the corresponding group of physical antennas.

For the direct path, the network node 402 may receive the RF signals from the primary UE 404 through the channel 424, which may be represented as H₁.

For the indirect path, the collaborating UE 406 may receive the RF signals from the primary UE 404 through the channel 428, which may be represented as H₂, and the network node 402 may receive the RF signals from the collaborating UE 406 through the channel 426, which may be represented as H₃. The collaborating UE 406 may relay or forward the received RF signals, with some necessary processing such as, but not limited to, amplification or linear combination, to the network node 402. The impact of the signal processing at the collaborating UE 406 to the received signals may be represented as G_{2×4}.

For the scenario of non-coherent joint transmission (NCJT) across two virtual panels where each layer is carried by one panel, the received signal r_{n×1} at the network node 402, if extracted from the RF signals received at the physical antennas of the network node 402, may be represented as:

$${r}_{n \times 1} = {H}_{{1}_{n \times 2}} \cdot {P}_{2 \times 2}^{′ ( 1 )} \cdot {x}_{2 \times 1}^{( 1 )} + {H}_{{3}_{n \times 2}} \cdot {G}_{2 \times 4} \cdot {H}_{{2}_{4 \times 2}} \cdot {P}_{2 \times 2}^{′ ( 2 )} \cdot {x}_{2 \times 1}^{( 2 )} \qquad Eq . ( 1 )$$

For the scenario of coherent joint transmission (CJT) across two virtual panels where each layer is carried by two panels, the degrees of freedom of the precoder design are increased (as an example, increased from 2×2 to 4×4), and the received signal r_{n×1} at the network node 402, if extracted from the RF signals received at the physical antennas of the network node 402, may be represented as:

$$\begin{matrix}{r}_{n \times 1} = ( {H}_{{1}_{n \times 2}} \cdot {P}_{2 \times 4}^{( 1 )} + {H}_{{3}_{n \times 2}} \cdot {G}_{2 \times 4} \cdot {H}_{{2}_{4 \times 2}} \cdot {P}_{2 \times 4}^{( 2 )} ) \cdot {x}_{4 \times 1} \\ = [ {\begin{matrix}{H}_{{1}_{n \times 2}} & {H}_{{3}_{n \times 2}} \cdot {G}_{2 \times 4} \cdot {H}_{{2}_{4 \times 2}} ]\end{matrix} [ \begin{matrix}{P}^{( 1 )} \\ {P}^{( 2 )}\end{matrix} ]}_{4 \times 4} \cdot {x}_{4 \times 1}\end{matrix} \qquad Eq . ( 2 )$$

In some implementations of device collaborative communications, for downlink transmission, the primary UE 404 may receive RF signal in the first frequency band f1 from the network node 402 via the direct path. The collaborating UE 406 may receive RF signal in the first frequency band f1 from the network node 402, shift the RF carrier of the RF signals to the second frequency band f2, and then transmit the shifted RF signals in the second frequency band f2 to the primary UE 404. In this manner, the primary UE 404 may receive the RF signal, which is originated from the network node 402, in the first frequency band f2 from the collaborating UE 406 via the indirect path.

To support device collaboration, various techniques, methods, schemes and/or solutions pertaining to configuring the measurement resources and CSI reports are described below.

In some implementations, a communication apparatus (e.g., a primary communication apparatus or a primary UE in device collaborative communications) which receives signals from the network node in a first frequency band (e.g., the first frequency band f1 in FIG. 2, FIG. 3 or FIG. 4) may transmit a capability report to the network node. The capability report may comprise information regarding a capability of supporting device collaboration and/or information regarding at least a second frequency band (e.g., the second frequency band f2 in FIG. 2, FIG. 3 or FIG. 4) to perform the device collaboration.

In some implementations, the primary communication apparatus may negotiate or communicate with the collaborating device (e.g., a collaborating communication apparatus or a collaborating UE in device collaborative communications) about the frequency band to perform the device collaboration before or after transmitting the capability report to the network node. Note that in some implementations, there may be more than one collaborating device to perform the device collaboration with the primary communication apparatus, and thus there may be more than one frequency band determined or selected to perform the device collaboration.

In some implementations, the frequency band to perform the device collaboration may be a licensed band or an unlicensed band. In some implementations, permission to use the frequency band for device collaboration from the network node may be required. The primary communication apparatus may negotiate or communicate with the network node about the frequency band to perform the device collaboration before or via transmitting the capability report to the network node.

In some implementations, in an event that the primary communication apparatus had reported its upgraded capability and/or its capability of supporting device collaboration to the network node (e.g., via the capability report), the primary communication apparatus may receive a first report configuration which is associated with at least a first measurement resource allocated in the first frequency band from the network node. In some implementations, the measurement resource may be in one of the following types: synchronization signal (SS) block or physical broadcast channel (PBCH) block (SSB), non-zero power channel state information reference signal (NZP-CSI-RS), CSI interference measurement (CSI-IM), tracking reference signal (TRS) and demodulation reference signal (DMRS).

In some implementations, the primary communication apparatus may determine information regarding a second measurement resource allocated in the second frequency band. In some implementations, the first frequency band may be different from the second frequency band.

The primary communication apparatus may receive a first RF signal carrying one or more reference signals on the first measurement resource and receive a second RF signal carrying one or more reference signals on the second measurement resource. In some implementations, said one or more reference signals carried in the first RF signal and said one or more reference signals carried in the second RF signal may be identical.

Regrading configuration of the measurement resource in two component carriers or two frequency bands (e.g., the frequency bands f1 and f2) for device collaborative communications, in one aspect, the first report configuration may be further associated with the second measurement resource. That is, the first report configuration may be associated with the first measurement resource and the second measurement resource and therefore, one report may be associated with the two measurement resources across two component carriers or two frequency bands. In such implementations, the information regarding the second measurement resource may be explicitly indicated by the first report configuration or may be determined based on the first report configuration.

In some implementations, the primary communication apparatus may perform channel state measurements of said one or more reference signals based on at least one of the first RF signal and the second RF signal and generate a channel state information (CSI) report based on the first report configuration and the channel state measurements on at least one of the first measurement resource and the second measurement resource (e.g., on one of the first measurement resource and the second measurement resource or on both the first measurement resource and the second measurement resource).

From the point of view of the primary communication apparatus, the measurement resources are configured in at least two bands (e.g., the frequency bands f1 and f2). One report is associated with at least two resources in the two bands. The primary communication apparatus may derive CSI (e.g., perform channel state measurements and accordingly generate the CSI report) by considering the reference signal (RS) received in the frequency bands f1 and f2 jointly. From the point of view of the network node, the two resources are transmitted as a single resource in only one frequency band (e.g., the frequency band f1).

In another aspect regarding the configuration of the measurement resource in two component carriers or two frequency bands for device collaborative communications, the second measurement resource may be mapped from the first measurement resource and a mapping between the first measurement resource and the second measurement resource may comprise an offset in frequency domain.

In some implementations, in the first report configuration, the primary communication apparatus may be configured with measurement resources in the frequency band f1 and the first report configuration may be associated with only the first measurement resource. That is, the first report configuration may be associated with measurement resource(s) in the frequency band f1 but not in the frequency band f2. In such implementations, the information regarding the second measurement resource may be implicitly indicated by the first report configuration or may be derived from the first report configuration. For example, given settings of the first measurement resource and the mapping rule of frequency translation from f1 to f2, which are obtained via the first report configuration, the primary communication apparatus can derive allocation of the second measurement resource. In addition, one CSI report may be associated with the two measurement resources across two components or two frequency bands.

In some implementations, the first report configuration may comprise an indicator which indicates that the CSI report is generated based on the channel state measurements on the first measurement resource, the channel state measurements on the second measurement resource, or the channel state measurements on both the first measurement resource and the second measurement resource.

In some implementations, the first report configuration may comprise an indicator (e.g., the indicator frequencyTranslationON) which indicates whether a frequency translation is turned on. In an event that the indicator indicates that the frequency translation is turned on, the primary communication apparatus may assume that the signal transmitted by the network node in the frequency band f1 is also transmitted in the frequency band f2 (or even more frequency bands, f3, f4, . . . etc., for the case when more than one collaborating device performs device collaboration with the primary communication apparatus), and the information regarding the second measurement resource may be derived from the first report configuration.

Note that for the case when more than one collaborating device performs device collaboration with the primary communication apparatus, there may be more than one indicator to indicate whether a frequency translation is turned on, and each indicator may correspond to an individual collaborating device or an individual frequency translation.

In some implementations, whether a value of the indicator frequency TranslationON is set to true or not may be indicated in the corresponding report configuration. In an event that the indicator frequencyTranslationON==TRUE, the primary communication apparatus may assume all reference signals received in the frequency band f1 are frequency-translated to the frequency band f2 (or even more frequency bands, f3, f4, . . . etc.), and derive CSI by considering reference signals received in multiple bands (e.g., f1 and f2) separately and/or jointly. In an event that the indicator frequencyTranslationON==FALSE, the primary communication apparatus may derive CSI according to the associated reference signals received in the frequency band f1.

In some implementations, the primary communication apparatus may negotiate with the collaborating device about the behavior in device collaborative communications in an event that the indicator frequency TranslationON is turned on or set to true.

In some implementations, a pre-defined mapping or a pre-configured rule, which may describe what frequency-translation does and maps resource(s) in the frequency band f1 to resource(s) in the frequency band f2, may be signaled to the primary communication apparatus. In some implementations, the mapping may be a constant offset in frequency domain. In some implementations, the information regarding the second measurement resource may be derived from the first report configuration based on the pre-defined mapping or based on the pre-configured rule.

Regarding the quasi co-location (QCL) rules for measurement resource reception in the frequency band f2, the primary communication apparatus may follow the QCL rules of the frequency band f1. In some implementations, the primary communication apparatus may apply a first QCL rule for reception of the first RF signal and apply a second QCL rule for reception of the second RF signal, wherein the second QCL rule is the same as the first QCL rule. Note that the implementation of applying the same QCL rule(s) in the device collaborative communications may be applicable to type A, type B, type C, type D, or any combination thereof. In one example, the QCL rules applied in the frequency band f1 to be followed by the frequency band f2 may not use SSB as QCL source.

Note that for the case when more than one collaborating device performs device collaboration with the primary communication apparatus, each collaborating device may correspond to at least one QCL rule. The primary communication apparatus may apply the corresponding QCL rule for reception of the RF signals from each collaborating device.

In some implementations, the QCL rule(s) may be configured based on the report configuration or configured based on the measurement resource. When the QCL rule is configured based on the measurement resource, each frequency band (e.g., the frequency band f1, f2, f3, f4, . . . etc.) may have a corresponding QCL rule. When the QCL rule is configured based on the report configuration, the QCL rules configured for the frequency band f1 will be followed by (e.g., applied in) the other frequency band f2, f3, f4, . . . etc.

In yet another aspect regarding the configuration of the measurement resource in two (or more) component carriers or two (or more) frequency bands for device collaborative communications, multiple report configurations may be provided by the network node. In some implementations, the primary communication apparatus may receive at least a first report configuration and a second report configuration from the network node, wherein the first report configuration corresponds to a first path and the second report configuration corresponds to the first path and a second path, or the first report configuration is associated with the first measurement resource and the second report configuration is associated with the second measurement resource.

In some implementations, the first path may be the direct path and the second path may be the indirect path. The primary communication apparatus may receive first RF signal carrying one or more reference signals on the first measurement resource via the first path and receive second RF signal carrying one or more reference signals on the second measurement resource via the second path. In some implementations, said one or more reference signals carried in the first RF signal and said one or more reference signals carried in the second RF signal may be identical.

The primary communication apparatus may perform channel state measurements of said one or more reference signals on the first measurement resource and generate a first CSI report based on the first report configuration and the channel state measurements on the first measurement resource. The primary communication apparatus may perform channel state measurements of said one or more reference signals on the second measurement resource and generate a second CSI report based on the second report configuration and the channel state measurements on the second measurement resource. The primary communication apparatus may also perform channel state measurements of said one or more reference signals on the first measurement resource and the second measurement resource and generate a CSI report based on the channel state measurements on the first measurement resource and the second measurement resource

In some implementations of multiple report configurations in device collaborative communications, the primary communication apparatus may receive a first report configuration, a second report configuration and a third report configuration from the network node, wherein the first report configuration is associated with the first measurement resource and/or corresponds to a first path (e.g., the direct path), the second report configuration is associated with the second measurement resource and/or corresponds to a second path (e.g., the indirect path) and the third report configuration is associated with the first measurement resource and the second measurement resource and/or corresponds to the first path and the second path.

The primary communication apparatus may perform channel state measurements of said one or more reference signals on the first measurement resource and generate a first CSI report based on the channel state measurements on the first measurement resource. The primary communication apparatus may perform channel state measurements of said one or more reference signals on the second measurement resource and generate a second CSI report based on the channel state measurements on the second measurement resource. The primary communication apparatus may perform channel state measurements or joint channel state measurements of said one or more reference signals on the first measurement resource and the second measurement resource and generate a third CSI report based on the channel state measurements or joint channel state measurements on the first measurement resource and the second measurement resource. One CSI report is associated with one report configuration.

In some implementations of multiple report configurations in device collaborative communications, the primary communication apparatus may receive an indication which indicates whether a CSI report is to be generated based on channel state measurements on the first measurement resource or on the second measurement resource or based on channel state measurements on the first measurement resource and the second measurement resource from the network node via a radio resource control (RRC) signaling or a physical downlink control channel (PDCCH) based signaling, such as downlink control information (DCI).

In some implementations, the indication to indicate based on which channel state measurements a CSI report is to be generated may be the aforementioned indicator frequency TranslationON or an indicator for path-selection outcome. In one example, the ON or OFF (or TRUE or FALSE) information for frequency-translation may be directly configured in the report configuration. For a CSI report to be generated, the associated report configuration explicitly indicates whether the RS received in the frequency band of device collaboration (e.g., the frequency band f2) due to frequency-translation are to be jointly considered or not.

In some implementations, for dynamic adaptation or dynamic path-selection between different transmission paths, the indication to indicate based on which channel state measurements a CSI report is to be generated may be dynamically provided by the network node via the PDCCH-based signaling.

In some implementations, for a mode-dependent approach, an indicator (e.g., the indicator frequency TranslationON or an indicator for path-selection outcome) may be utilized to indicate whether the primary communication apparatus should assume the signal transmitted by the network node in the frequency band f1 is also transmitted in the frequency band f2 or not. This indicator may be included in the report configuration.

In some implementations, the channel state measurements to be performed by the primary communication apparatus may be dependent on whether the frequency-translation is enabled or not. For a CSI report (or a corresponding report configuration), the primary communication apparatus may take the ON/OFF pattern for the frequency-translation of the collaborating communication apparatus (or take the path-selection result) into account to determine whether the RS received in the frequency band of device collaboration (e.g., the frequency band f2) are be jointly considered or not.

In one example, for diversity augmentation as the scenario shown in FIG. 2, if the RS for measurement is expected to be forwarded, the CSI may be derived according to reference signals measured in the frequency band f2. Otherwise, the CSI may be derived according to RS measured in the frequency band f1 only. In another example, for rank augmentation as the scenario shown in FIG. 3, if the RS for measurement is expected to be forwarded, the CSI may be derived according to RS measured in the frequency band f2. Otherwise, the CSI may be derived according to RS measured in the frequency band f1 only.

In some implementations, for dynamic adaptation or dynamic path-selection between different transmission paths, a PDCCH-based signaling may be used to indicate the dynamic switch or path-selection outcome on the basis when the indicator is included in the report configuration.

Note that in some implementations, to save configuration overhead, the indication to indicate based on which channel state measurements a CSI report is to be generated (such as the aforementioned indicator frequency TranslationON or an indicator for path-selection outcome) may not be included in the report configuration. In such implementations, the indication may be provided to the primary communication apparatus by any type of signaling.

With respect to the operations of a network node in device collaborative communications, in some implementations, the network node may receive a capability report from a communication apparatus (e.g., the primary communication apparatus) which receives signals from the network node in a first frequency band, wherein the capability report comprises information regarding a capability of supporting device collaboration and information regarding at least a second frequency band different from the first frequency band to perform the device collaboration.

With the information carried in the capability report, the network node may configure a first measurement resource in the first frequency band and transmit a first report configuration associated with the first measurement resource to the communication apparatus. In some implementations, information regarding a second measurement resource allocated in the second frequency band may be implicitly or explicitly indicated by the first report configuration.

In one example of explicit indication, the first report configuration may be associated with both the first measurement resource and the second measurement resource, and the information regarding the second measurement resource may be determined based on the first report configuration.

In one example of implicit indication, the second measurement resource may be mapped from the first measurement resource and a mapping between the first measurement resource and the second measurement resource may comprise an offset in frequency domain.

In some implementations, the first report configuration may comprise an indicator which indicates whether a frequency translation is turned on. In an event that the indicator indicates that the frequency translation is turned on, the information regarding the second measurement resource may be derived from the first report configuration.

In some implementations, the network node may configure multiple measurement resources corresponding to multiple transmission paths, such as a direct path and one or more indirect paths, and transmit multiple report configurations each being associated with one measurement resource to the communication apparatus.

In some implementations of multiple report configurations in device collaborative communications, the network node may transmit an indication which indicates based on which channel state measurements (or based on the channel state measurements of which transmission path) a CSI report is to be generated by the communication apparatus via an RRC signaling or a PDCCH-based signaling, such as DCI.

### Illustrative Implementations

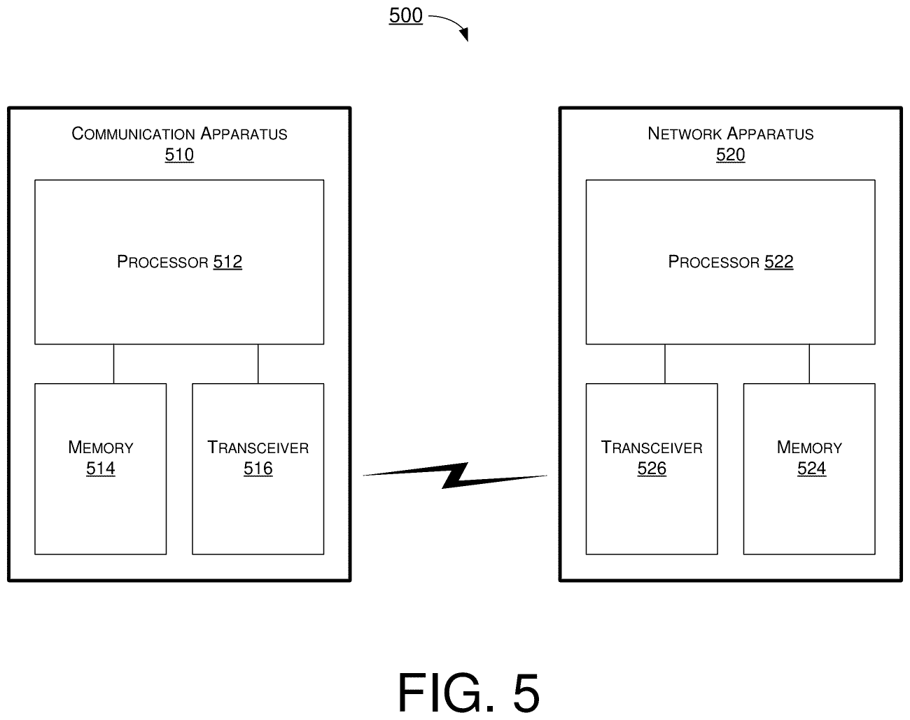

FIG. 5 illustrates an example communication system 500 having an example communication apparatus 510 and an example network apparatus 520 in accordance with an implementation of the present disclosure. Each of the communication apparatus 510 and the network apparatus 520 may perform various functions to implement schemes, techniques, processes and methods described herein pertaining to measurement resource and report configuration for device collaborative communications, including scenarios/schemes described above as well as the process 600 and process 700 described below.

Communication apparatus 510 may be a part of an electronic apparatus, which may be a UE such as a portable or mobile apparatus, a wearable apparatus, a wireless communication apparatus or a computing apparatus. For instance, the communication apparatus 510 may be implemented in a smartphone, a smartwatch, a personal digital assistant, a digital camera, or a computing equipment such as a tablet computer, a laptop computer or a notebook computer. The communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, the communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 510 may include at least some of those components shown in FIG. 5 such as a processor 512, for example. The communication apparatus 510 may further include one or more other components not pertinent to the proposed scheme of the present disclosure (e.g., internal power supply, display device and/or user interface device), and, thus, such component(s) of the communication apparatus 510 are neither shown in FIG. 5 nor described below in the interest of simplicity and brevity.

The network apparatus 520 may be a part of a network device, which may be a network node such as a satellite, a base station, a small cell, a router or a gateway. For instance, the network apparatus 520 may be implemented in an eNodeB in an LTE network, in a gNB in a 5G/NR, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. The network apparatus 520 may include at least some of those components shown in FIG. 5 such as a processor 522, for example. The network apparatus 520 may further include one or more other components not pertinent to the proposed scheme of the present disclosure (e.g., internal power supply, display device and/or user interface device), and, thus, such component(s) of the network apparatus 520 are neither shown in FIG. 5 nor described below in the interest of simplicity and brevity.

In one aspect, each of the processor 512 and the processor 522 may be implemented in the form of one or more single-core processors, one or more multi-core processors, or one or more CISC processors. That is, even though a singular term “a processor” is used herein to refer to the processor 512 and the processor 522, each of the processor 512 and the processor 522 may include multiple processors in some implementations and a single processor in other implementations in accordance with the present disclosure. In another aspect, each of the processor 512 and the processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512 and the processor 522 is a special-purpose machine specifically designed, arranged and configured to perform specific tasks including autonomous reliability enhancements in a device (e.g., as represented by communication apparatus 510) and a network (e.g., as represented by network apparatus 520) in accordance with various implementations of the present disclosure.

In some implementations, the communication apparatus 510 may also include a transceiver 516 coupled to the processor 512 and capable of wirelessly transmitting and receiving data. In some implementations, the communication apparatus 510 may further include a memory 514 coupled to the processor 512 and capable of being accessed by the processor 512 and storing data therein. In some implementations, the network apparatus 520 may also include a transceiver 526 coupled to the processor 522 and capable of wirelessly transmitting and receiving data. In some implementations, the network apparatus 520 may have a plurality of physical antennas which associates with a plurality of antenna ports. In some implementations, the network apparatus 520 may further include a memory 524 coupled to processor 522 and capable of being accessed by the processor 522 and storing data therein. Accordingly, communication apparatus 510 and the network apparatus 520 may wirelessly communicate with each other via the transceiver 516 and the transceiver 526, respectively. To aid better understanding, the following description of the operations, functionalities and capabilities of each of the communication apparatus 510 and the network apparatus 520 is provided in the context of a mobile communication environment in which the communication apparatus 510 is implemented in or as a communication apparatus or a UE and the network apparatus 520 is implemented in or as a network node or a network device of a communication network.

In some implementations, the processor 512 of the communication apparatus 510 may receive, via the transceiver 516, a first report configuration from a network node, such as the network apparatus 520. The first report configuration may be associated with at least a first measurement resource allocated in a first frequency band. The processor 512 may determine information regarding a second measurement resource allocated in a second frequency band, wherein the first frequency band may be different from the second frequency band. The processor 512 may receive, via the transceiver 516, a first RF signal carrying one or more reference signals on the first measurement resource and receive a second RF signal carrying said one or more reference signals on the second measurement resource. In some implementations, said one or more reference signals carried in the first RF signal and said one or more reference signals carried in the second RF signal may be identical.

In some implementations, the processor 512 may perform channel state measurements of said one or more reference signals based on at least one of the first RF signal and the second RF signal and generate a CSI report based on the first report configuration and the channel state measurements on one of the first measurement resource and the second measurement resource or on both the first measurement resource and the second measurement resource.

In some implementations, first report configuration comprises an indicator which indicates that the processor generates the CSI report based on the channel state measurements on the first measurement resource, the channel state measurements on the second measurement resource, or the channel state measurements on both the first measurement resource and the second measurement resource.

In some implementations, the first report configuration may be further associated with the second measurement resource, and the information regarding the second measurement resource may be determined based on the first report configuration.

In some implementations, the second measurement resource may be mapped from the first measurement resource and a mapping between the first measurement resource and the second measurement resource may comprise an offset in frequency domain.

In some implementations, the first report configuration may comprise an indicator which indicates whether a frequency translation is turned on, and in an event that the indicator indicates that the frequency translation is turned on, the information regarding the second measurement resource may be derived from the first report configuration.

In some implementations, the processor 512 may receive, via the transceiver 516, a second report configuration from the network node. The second report configuration may be associated with the second measurement resource. The processor 512 may perform channel state measurements of said one or more reference signals on the second measurement resource. The processor 512 may generate a CSI report based on the second report configuration and the channel state measurements on the second measurement resource.

In some implementations, the processor 512 may receive, via the transceiver 516, a third report configuration from the network node. The third report configuration may be associated with the first measurement resource and the second measurement resource. The processor 512 may perform channel state measurements of said one or more reference signals on the first measurement resource and the second measurement resource. The processor 512 may generate a CSI report based on the third report configuration and the channel state measurements on the first measurement resource and the second measurement resource.

In some implementations, the processor 512 may receive, via the transceiver 516, an indication which indicates whether a CSI report is to be generated based on channel state measurements on the first measurement resource or the second measurement resource or based on channel state measurements on the first measurement resource and the second measurement resource from the network node via an RRC signaling or a PDCCH-based signaling.

In some implementations, the processor 512 may apply a first QCL rule for reception of the first RF signal and apply a second QCL rule for reception of the second RF signal, wherein the second QCL rule may be the same as the first QCL rule.

In some implementations, the processor 522 of the network apparatus 520 may receive a capability report from a communication apparatus, such as the communication apparatus 510, which receives signals from the network apparatus 520 in a first frequency band. The capability report may comprise information regarding a capability of supporting device collaboration and information regarding at least a second frequency band to perform the device collaboration, and the first frequency band may be different from the second frequency band. The processor 522 may configure a first measurement resource in the first frequency band and transmit a first report configuration associated with the first measurement resource to the communication apparatus. Information regarding a second measurement resource allocated in the second frequency band may be implicitly or explicitly indicated by the first report configuration.

In some implementations, the first report configuration may be associated with the second measurement resource, and the information regarding the second measurement resource may be determined based on the first report configuration.

In some implementations, the second measurement resource may be mapped from the first measurement resource and a mapping between the first measurement resource and the second measurement resource may comprise an offset in frequency domain.

In some implementations, the first report configuration may comprise an indicator which indicates whether a frequency translation is turned on, and in an event that the indicator indicates that the frequency translation is turned on, the information regarding the second measurement resource may be derived from the first report configuration.

### Illustrative Processes

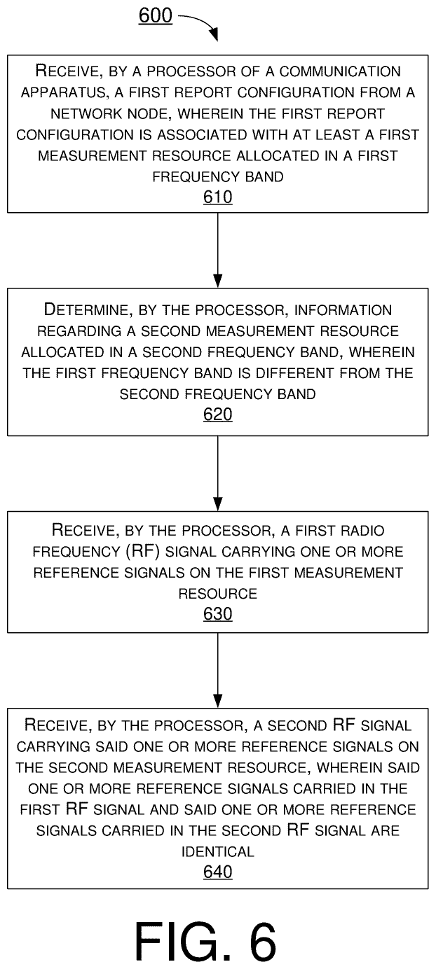

FIG. 6 depicting an example process 600 in accordance with an implementation of the present disclosure. The process 600 may be an example implementation of above scenarios/schemes, whether partially or completely, with respect to measurement resource and report configuration for device collaborative communications in accordance with the present disclosure. The process 600 may represent an aspect of implementation of features of the communication apparatus 510. The process 600 may include one or more operations, actions, or functions as illustrated by one or more of blocks 610, 620, 630 and 640. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the communication apparatus 510 or any suitable UE or machine type devices. Solely for illustrative purposes and without limitation, the process 600 is described below in the context of the communication apparatus 510. The process 600 may begin at block 610.

At 610, the process 600 may involve the processor 512 of the communication apparatus 510 receiving a first report configuration from a network node, such as the network apparatus 520, wherein the first report configuration may be associated with at least a first measurement resource allocated in a first frequency band. The process 600 may proceed from 610 to 620.

At 620, the process 600 may involve the processor 512 determining information regarding a second measurement resource allocated in a second frequency band, wherein the first frequency band is different from the second frequency band. The first frequency band may be different from the second frequency band. The process 600 may proceed from 620 to 630.

At 630, the process 600 may involve the processor 512 receiving a first RF signal carrying one or more reference signals on the first measurement resource. The process 600 may proceed from 630 to 640.

At 640, the process 600 may involve the processor 512 receiving a second RF signal carrying said one or more reference signals on the second measurement resource. Said one or more reference signals carried in the first RF signal and said one or more reference signals carried in the second RF signal may be identical.

In some implementations, the process 600 may involve the processor 512 performing channel state measurements of said one or more reference signals based on at least one of the first RF signal and the second RF signal and generating a CSI report based on the first report configuration and the channel state measurements on one of the first measurement resource and the second measurement resource or on both the first measurement resource and the second measurement resource.

In some implementations, the first report configuration may comprise an indicator which indicates that the processor generates the CSI report based on the channel state measurements on the first measurement resource, the channel state measurements on the second measurement resource, or the channel state measurements on both the first measurement resource and the second measurement resource.

In some implementations, the first report configuration may be further associated with the second measurement resource, and the information regarding the second measurement resource may be determined based on the first report configuration.

In some implementations, the second measurement resource may be mapped from the first measurement resource and a mapping between the first measurement resource and the second measurement resource may comprise an offset in frequency domain.

In some implementations, the first report configuration may comprise an indicator which indicates whether a frequency translation is turned on, and in an event that the indicator indicates that the frequency translation is turned on, the information regarding the second measurement resource may be derived from the first report configuration.

In some implementations, the process 600 may involve the processor 512 receiving a second report configuration from the network node. The second report configuration may be associated with the second measurement resource. In some implementations, the process 600 may involve the processor 512 performing channel state measurements of said one or more reference signals on the second measurement resource. In some implementations, the process 600 may involve the processor 512 generating a CSI report based on the second report configuration and the channel state measurements on the second measurement resource.

In some implementations, the process 600 may involve the processor 512 receiving a third report configuration from the network node. The third report configuration may be associated with the first measurement resource and the second measurement resource. In some implementations, the process 600 may involve the processor 512 performing channel state measurements of said one or more reference signals on the first measurement resource and the second measurement resource. In some implementations, the process 600 may involve the processor 512 generating a CSI report based on the third report configuration and the channel state measurements on the first measurement resource and the second measurement resource.

In some implementations, the process 600 may involve the processor 512 receiving an indication which indicates whether a CSI report is to be generated based on channel state measurements on the first measurement resource or the second measurement resource or based on channel state measurements on the first measurement resource and the second measurement resource from the network node via an RRC signaling or a PDCCH-based signaling.

In some implementations, the process 600 may involve the processor 512 applying a first QCL rule for reception of the first RF signal and applying a second QCL rule for reception of the second RF signal, wherein the second QCL rule may be the same as the first QCL rule.

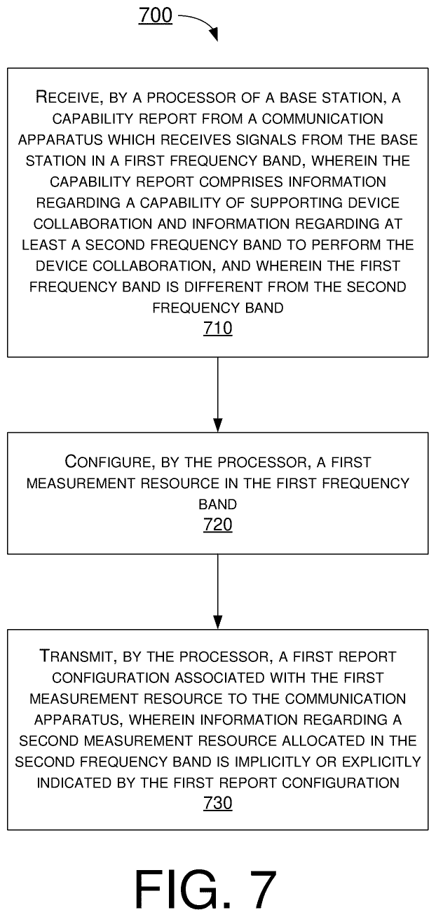

FIG. 7 depicting an example process 700 in accordance with an implementation of the present disclosure. The process 700 may be an example implementation of above scenarios/schemes, whether partially or completely, with respect to measurement resource and report configuration for device collaborative communications in accordance with the present disclosure. The process 700 may represent an aspect of implementation of features of the network apparatus 520. The process 700 may include one or more operations, actions, or functions as illustrated by one or more of blocks 710, 720 and 730. Although illustrated as discrete blocks, various blocks of the process 700 may be divided into additional blocks, combined into fewer blocks, or eliminated, depending on the desired implementation. Moreover, the blocks of the process 700 may be executed in the order shown in FIG. 7 or, alternatively, in a different order. The process 700 may be implemented by the network apparatus 520, such as a base station or any suitable network device or network node. Solely for illustrative purposes and without limitation, the process 700 is described below in the context of the network apparatus 520. The process 700 may begin at block 710.

At 710, the process 700 may involve the processor 522 of the network apparatus 520 (e.g., a processor of the base station) receiving a capability report from a communication apparatus, such as the communication apparatus 510, which receives signals from the network apparatus 520 in a first frequency band. The capability report may comprise information regarding a capability of supporting device collaboration and information regarding at least a second frequency band to perform the device collaboration. The first frequency band may be different from the second frequency band. The process 700 may proceed from 710 to 720.

At 720, the process 700 may involve the processor 522 configuring a first measurement resource in the first frequency band. The process 700 may proceed from 720 to 730.

At 730, the process 700 may involve the processor 522 transmitting a first report configuration associated with the first measurement resource to the communication apparatus. Information regarding a second measurement resource allocated in the second frequency band may be implicitly or explicitly indicated by the first report configuration.

In some implementations, the first report configuration may be associated with the second measurement resource, and the information regarding the second measurement resource may be determined based on the first report configuration.

In some implementations, the second measurement resource may be mapped from the first measurement resource and a mapping between the first measurement resource and the second measurement resource may comprise an offset in frequency domain.

In some implementations, the first report configuration may comprise an indicator which indicates whether a frequency translation is turned on, and in an event that the indicator indicates that the frequency translation is turned on, the information regarding the second measurement resource may be derived from the first report configuration.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a first report configuration from a network node, wherein the first report configuration is associated with at least a first measurement resource allocated in a first frequency band;
determining, by the processor, information regarding a second measurement resource allocated in a second frequency band, wherein the first frequency band is different from the second frequency band;
receiving, by the processor, a first radio frequency (RF) signal carrying one or more reference signals on the first measurement resource; and
receiving, by the processor, a second RF signal carrying said one or more reference signals on the second measurement resource,
wherein said one or more reference signals carried in the first RF signal and said one or more reference signals carried in the second RF signal are identical.

2. The method of claim 1, further comprising:
performing, by the processor, channel state measurements of said one or more reference signals based on at least one of the first RF signal and the second RF signal; and
generating, by the processor, a channel state information (CSI) report based on the first report configuration and the channel state measurements on one of the first measurement resource and the second measurement resource or on both the first measurement resource and the second measurement resource.

3. The method of claim 2, wherein the first report configuration comprises an indicator which indicates that the processor generates the CSI report based on the channel state measurements on the first measurement resource, the channel state measurements on the second measurement resource, or the channel state measurements on both the first measurement resource and the second measurement resource.

4. The method of claim 1, wherein the first report configuration is further associated with the second measurement resource and the information regarding the second measurement resource is determined based on the first report configuration, or wherein the second measurement resource is mapped from the first measurement resource and a mapping between the first measurement resource and the second measurement resource comprises an offset in frequency domain.

5. The method of claim 1, wherein the first report configuration comprises an indicator which indicates whether a frequency translation is turned on, and wherein in an event that the indicator indicates that the frequency translation is turned on, the information regarding the second measurement resource is derived from the first report configuration.

6. The method of claim 1, further comprising:
receiving, by the processor, a second report configuration from the network node, wherein the second report configuration is associated with the second measurement resource;
performing, by the processor, channel state measurements of said one or more reference signals on the second measurement resource; and
generating, by the processor, a CSI report based on the second report configuration and the channel state measurements on the second measurement resource.

7. The method of claim 1, further comprising:
receiving, by the processor, a third report configuration from the network node, wherein the third report configuration is associated with the first measurement resource and the second measurement resource;
performing, by the processor, channel state measurements of said one or more reference signals on the first measurement resource and the second measurement resource; and
generating, by the processor, a CSI report based on the third report configuration and the channel state measurements on the first measurement resource and the second measurement resource.

8. The method of claim 1, further comprising:
receiving, by the processor, an indication which indicates whether a CSI report is to be generated based on channel state measurements on the first measurement resource or the second measurement resource or based on channel state measurements on the first measurement resource and the second measurement resource from the network node via a radio resource control (RRC) signaling or a physical downlink control channel (PDCCH) based signaling.

9. An apparatus, comprising:
a transceiver which, during operation, wirelessly communicates with at least one network node; and
a processor communicatively coupled to the transceiver such that, during operation, the processor performs operations comprising:
receiving, via the transceiver, a first report configuration from the network node, wherein the first report configuration is associated with at least a first measurement resource allocated in a first frequency band;
determining information regarding a second measurement resource allocated in a second frequency band, wherein the first frequency band is different from the second frequency band;
receiving, via the transceiver, a first radio frequency (RF) signal carrying one or more reference signals on the first measurement resource; and
receiving, via the transceiver, a second RF signal carrying said one or more reference signals on the second measurement resource,
wherein said one or more reference signals carried in the first RF signal and said one or more reference signals carried in the second RF signal are identical.

10. The apparatus of claim 9, wherein, during operation, the processor further performs operations comprising:
performing channel state measurements of said one or more reference signals based on at least one of the first RF signal and the second RF signal; and
generating a channel state information (CSI) report based on the first report configuration and the channel state measurements on one of the first measurement resource and the second measurement resource or on both the first measurement resource and the second measurement resource.

11. The apparatus of claim 10, wherein the first report configuration comprises an indicator which indicates that the processor generates the CSI report based on the channel state measurements on the first measurement resource, the channel state measurements on the second measurement resource, or the channel state measurements on both the first measurement resource and the second measurement resource.

12. The apparatus of claim 9, wherein the first report configuration is further associated with the second measurement resource and the information regarding the second measurement resource is determined based on the first report configuration, or wherein the second measurement resource is mapped from the first measurement resource and a mapping between the first measurement resource and the second measurement resource comprises an offset in frequency domain.

13. The apparatus of claim 9, wherein the first report configuration comprises an indicator which indicates whether a frequency translation is turned on, and wherein in an event that the indicator indicates that the frequency translation is turned on, the information regarding the second measurement resource is derived from the first report configuration.

14. The apparatus of claim 9, wherein, during operation, the processor further performs operations comprising:
receiving, via the transceiver, a second report configuration from the network node, wherein the second report configuration is associated with the second measurement resource;
performing channel state measurements of said one or more reference signals on the second measurement resource; and
generating a CSI report based on the second report configuration and the channel state measurements on the second measurement resource.

15. The apparatus of claim 9, wherein, during operation, the processor further performs operations comprising:
receiving, via the transceiver, a third report configuration from the network node, wherein the third report configuration is associated with the first measurement resource and the second measurement resource;
performing channel state measurements of said one or more reference signals on the first measurement resource and the second measurement resource; and
generating, by the processor, a CSI report based on the third report configuration and the channel state measurements on the first measurement resource and the second measurement resource.

16. The apparatus of claim 9, wherein, during operation, the processor further performs operations comprising:
receiving, via the transceiver, an indication which indicates whether a CSI report is to be generated based on channel state measurements on the first measurement resource or the second measurement resource or based on channel state measurements on first measurement resource and the second measurement resource from the network node via a radio resource control (RRC) signaling or a physical downlink control channel (PDCCH) based signaling.

17. A method, comprising:
receiving, by a processor of a base station, a capability report from a communication apparatus which receives signals from the base station in a first frequency band, wherein the capability report comprises information regarding a capability of supporting device collaboration and information regarding at least a second frequency band to perform the device collaboration, and wherein the first frequency band is different from the second frequency band;
configuring, by the processor, a first measurement resource in the first frequency band; and
transmitting, by the processor, a first report configuration associated with the first measurement resource,
wherein information regarding a second measurement resource allocated in the second frequency band is implicitly or explicitly indicated by the first report configuration.

18. The method of claim 17, wherein the first report configuration is associated with the second measurement resource, and wherein the information regarding the second measurement resource is determined based on the first report configuration.

19. The method of claim 17, wherein the second measurement resource is mapped from the first measurement resource and a mapping between the first measurement resource and the second measurement resource comprises an offset in frequency domain.

20. The method of claim 17, wherein the first report configuration comprises an indicator which indicates whether a frequency translation is turned on, and wherein in an event that the indicator indicates that the frequency translation is turned on, the information regarding the second measurement resource is derived from the first report configuration.
